(19) United States
(12) Patent Application Publication
(10) Pub. No.: US 2003/0037329 A1
(43) Pub. Date: Feb. 20, 2003

(54) Alternative video program display control system

(75) Inventors: Tony E. Piotrowski, Wayne, NJ (US); Daniel J. Piotrowski, Edison, NJ (US)

Correspondence Address: PHILIPS CORPORATION, Intellectual Property Department, 580 White Plains Road, Tarrytown, NY, 10591, US

(73) Assignee: Koninklijke Philips Electronics N.V.

(21) Appl. No.: 09/847,223

(22) Filed: May 2, 2001

(51) Int. Cl. H04N 7/16; H04N 7/025; H04N 7/10

(52) U.S. Cl. 725/28; 725/34

(57) ABSTRACT

An arrangement for the control of viewing of a video/television program in which a rating code and an alternative segment code are transmitted with the video/television signal. The codes are decoded and processed via a microcontroller. A viewer of the video signal is able to enter codes of permitted program ratings using a remote control unit. The rating codes are based upon the content of the video signal. Alternative segments for the video/television signal may be substituted for possibly objectionable content based upon a comparison of the received codes and the permitted program ratings segments of video/television signal.

### FIELD OF THE INVENTION

The invention relates to a system and method controlling video/television program display in dependence on the program content, in particular, the method and system allow for display-control of alternative content in dependence on predetermined program content rating selections.

### BACKGROUND OF THE INVENTION

In the U.S., a so called “V-chip” is used monitor codes transmitted with a television signal and disable the television receiver display when the codes indicate forbidden program material including scenes of violence, sex or other matter which might be considered objectionable by some audiences or unsuitable for children. Parents, for example, can formulate their decision on the basis of ratings that are assigned to movies and TV programs by an appointed board that views them before broadcast. Broadcasters may rate their program in four censorship categories. The values for each category are then transmitted simultaneously as part of the extended data services (EDS) of the Closed Captioning (CC) system. In particular, V-chip data is sent as a packet as part of the EDS provided on line 21 field 2 data. The V-chip data is transmitted for as long as the program is on the air.

The EDS are additional services that may be used/performed related to a TV program. The EDS provides the viewer information such as: current program title, type of show, length of show, and time left in show. In addition, as discussed above, EDS provides the transport mechanism to identify advisories about mature program content.

An advantage of using V-Chip is that the program blocking is independent of the channel where the program is being transmitted. As long as a data packet (sent during the Vertical Blanking Interval) containing rating information is received and the blocking criterion is met, the program will be blocked irrespective of the channel.

Using an access control mechanism, parent may set a predetermined threshold for each category. If a rating exceeds the pre-authorised value, the V-chip; suppresses the video and audio signals. As the reaction of the V-chip decoder is near instantaneous, the system can easily handle channel hopping. Moreover, the parent does not have to worry about missing content warnings in TV guides or at the start of programmes.

The Electronic Industries Association (EIA) defines the four censorship categories and the number of data bits required to transmit the code:

MPAA rating (equivalent to film classifications, e.g. 18, PG, etc.)—3 bits

violence content advisory level—2 bits (which allows for a scale of 0 to 3)

sexual content advisory level—2 bits

mature content advisory level—2 bits.

A CC decoder is used to provide subtitling on the display screen. Current CC decoders (such as the SAA5252 decoder sold by Philips Semiconductors) are capable of blanking out the TV picture when switched into full-text mode. They also have adequate display features to generate an on screen display (OSD) menu so that parents can program the censorship thresholds.

The concept of enabling a parent to control viewing of a television receiver using information transmitted by the broadcaster is not new and was proposed in WO83/02208 published on Jun. 23, 1983. In that document it is proposed that a code is sent via the teletext signal transmitted with the television signal, the code being formed as a selected row number of a given teletext page. Thus the page number and row number is transmitted in the field blanking period on the occurrence of a possibly offensive event. At the receiver a teletext decoder is permanently set to look for the relevant page and identify the row number as and when transmitted. The particular row numbers indicated particular grading of sound and vision events.

These arrangements, however, typically require a parent, or other responsible person, to enter an appropriate code into the television receiver and/or video recorder that is applied to all programs. The program block is all or nothing. Thus, even if only a small portion of the program is objectionable, the entire program is blocked depending on the code classification program.

This type of total blocking raises questions about censorship by some. There thus exists in the art a need for improved methods and systems for providing alternatives to total blocking of program content while still allowing viewers to screen objectionable content.

### SUMMARY OF THE INVENTION

One aspect of the invention is directed to a method of providing alternative information for a video program. The method includes the steps of receiving a video signal including at least one rating code representing a program classification for a segment of the video signal and at least one alt-location code and comparing the rating code with a predetermined program code. A determination is made as to whether an alternative segment is available based upon the alt-location code. The alternative segment may be substituted for the segment of the video program depending on the rating code.

Another aspect of the invention is directed to a television receiver that can receive a television signal that has a rating code representing a program classification for a segment of the television signal and an alt-segment code inserted in a vertical blanking interval. The rating code and the alt-segment code are extracted. The rating code is compared with a predetermined program code. The receiver then determines whether an alternative segment is available based upon the alt-segment code and whether it should be substituted for the segment of the television signal.

These and other features and advantages of the present invention will become more apparent from the accompanying drawings and the following detailed description.

### BRIEF DESCRIPTION OF THE DRAWINGS

FIG. 1 shows a video/television system.

FIG. 2 shows in block schematic of a television system in accordance with one embodiment of the present invention.

FIG. 3 illustrates data contained in a video signal and an arrangement for providing alternative video program content in accordance with one embodiment of the invention.

### DETAILED DESCRIPTION OF THE INVENTION

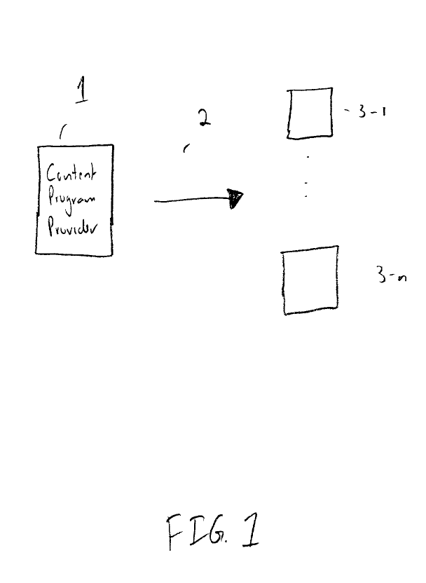

The system shown in FIG. 1 includes a signal/program source 1, a transmission medium 2, and a plurality of receivers 3-1 to 3-n. The program source 1 may be conventional television broadcast equipment, e.g., terrestrial broadcast, satellite broadcast or a cable television source. The program source 1 includes a closed caption or teletext inserter and means for entering program classification codes into the EDS data.

The transmission medium 2 may take any convenient form for example it could be radio waves as broadcast by a terrestrial transmitter or a satellite transmitter or could be a cable network for a cable TV system. The receivers 3-1 to 3-n are connected to the program source 1 via the transmission medium 2.

Another possible program source 1 is a video tape or disc on which a program is recorded for replay by a video tape recorder or a video disc player in which the case the transmission link 2 may be simply the tape recorder or disc player and a cable connecting the tape recorder or disc player to the television receiver.

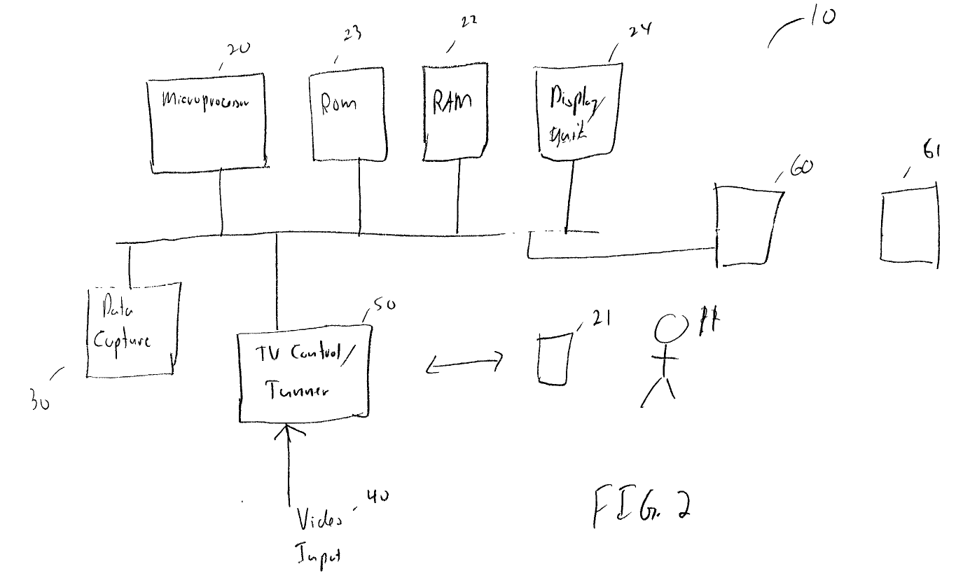

The receiver 3-1 to 3-n should be equipped with extended data services (EDS) of the Closed Captioning (CC) capability or a similar functionality, e.g., teletext. FIG. 2 shows a block diagram of a television receiver 10 with CC and EDS capability. A data capture module 30 is configured to receive composite video signal (i.e., a TV program) from a TV control/tuner circuit 50. Blanking signals (i.e., the content advisory packet) are extracted from line 21 of the vertical blanking interval in the composite video signal. The content advisory packet is then processed via a microprocessor executing application software.

In particular, a control processor 20 controls in conventional fashion the operation of the television receiver 10. It may receive control instructions from a remote control unit 21 which a viewer 11 uses to select a particular channel for display and selects other functions such as CC display or on screen menu displays.

The control processor 20 receives from the data capture module 30 codes which are present in a received signal 40. The received signal 40 is provided from the program source 1. The codes represent the content of sexual matter, violent matter, distressing matter or mature language as associated with various real-time segments of the signal 40. The control processor 20 may store the codes within a memory 22 and/or 23. Input signals that have been entered by the viewer 11 using the remote control unit 21 may also be stored. These input signals set the levels of sexual, violent, distressing or mature language content which are acceptable for display.

The control processor 20 compares the received codes with the input signal and depending on the output of that comparison will produce a signal to the TV control/tuner 50 or a display unit 24 which in appropriate circumstances will cause the display unit 24 to blank an image display and/or mute the audio.

In a preferred embodiment, the functions of the receiver 10 are implemented by computer readable program code executed by the control processor 20. The program code may be stored in the memory 23 or read/downloaded from a memory medium such as a CD-ROM or floppy disk. In other embodiments, hardware circuitry may be used in place of, or in combination with, software instructions to implement the invention. For example, the invention may be implemented on a digital television platform using a Trimedia processor for processing and a television monitor for display. The receiver 10 may also include a network connection 60 for interfacing to a data network, such as a variable-bandwidth network or the Internet or the public switched telephone network (PSTN).

In the current US content advisory system (see EIA/CEA-608-B), a content advisory packet includes two characters that contain information about the program's MPAA rating and the TV Parental Guidelines. These two systems are mutually exclusive, so if one is included the other shall not be. The following chart indicates the contents of the characters:

| Character | b6 | b5 | b4 | b3 | b2 | b1 | b0 |
|---|---|---|---|---|---|---|---|
| MPAA Rating | 1 | D | a1 | a0 | r2 | r1 | r0 |
| TV Parental Guidelines | 1 | (F) V | S | L | g2 | g1 | g0 |

For example, the three bits r0-r2 are used to encode the MPAA picture rating if used.

| r2 | r1 | r0 | Rating |
|---|---|---|---|
| 0 | 0 | 0 | N/A |
| 0 | 0 | 1 | ″G″ |
| 0 | 1 | 0 | ″ PG″ |
| 0 | 1 | 1 | ″PG-13″ |
| 1 | 0 | 0 | ″R″ |
| 1 | 0 | 1 | ″NC-17″ |
| 1 | 1 | 0 | ″X″ |
| 1 | 1 | 1 | Not Rated |

When a rating higher than the rating level selected (by the program viewer or parent) is received, blocking will take place. The entire screen will be blanked, audio will be muted and CC information will not be shown (even if it is active). Once an acceptable rating level is received, unblocking will take place. The screen will be unblanked, audio will be unmuted and CC information display will resume (if necessary). In some applications, if “No content rating data received” after waiting a predetermined amount of time, e.g., 5 seconds, the transmission is unblocked if blocked previously.

One embodiment of the present invention allows for more control of what information is blocked and what is display as an alternative to the original program content. As discussed above, a content advisory packet would be sent when a rating change occurred within a program being displayed. The rating change may indicate that a portion of the program should be blocked. This embodiment allows for automatic substitution of alternative program content within the same program portion. This process would appear seamless to the viewer.

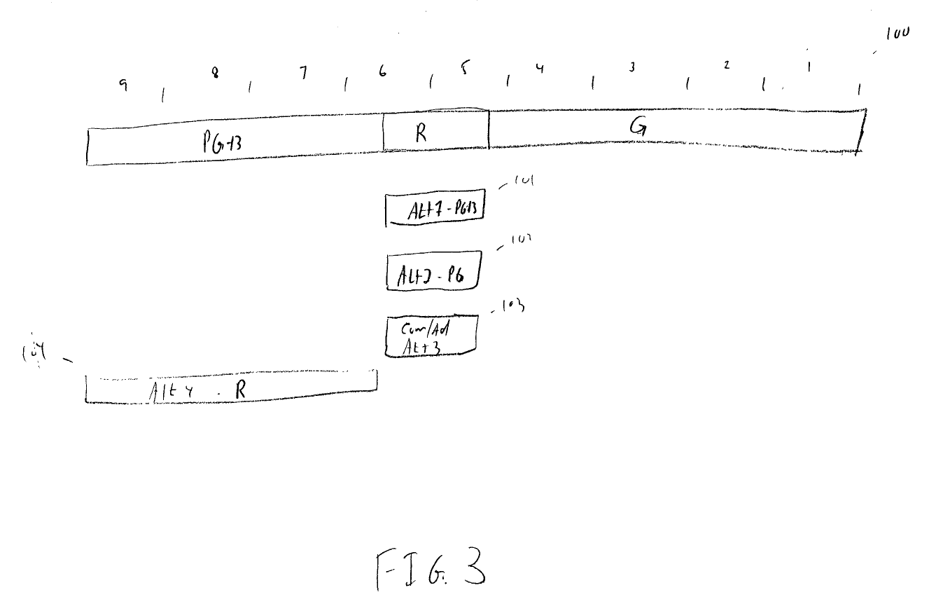

Illustratively, FIG. 3 show a program 100 which has been segmented into 9 segments. The number and real time lengths of each segment may vary depending on the content of the program 100. Each segment or portion thereof has an associated content rating code 101 (e.g., G, PG-13 and R). The content rating codes 101 are associated/inserted in the program 100 based upon the program content. For example, in segments 1-4, the content of the program 100 is rated G for general audiences. As discussed above, the content rating codes 101 are extracted by the data capture module 30 and processed accordingly.

Also shown are three alternatives (alt1-alt3) for particular segments of the program 100. In particular, in this example, the program content provider 1 has provided three alternative segments 101, 102 and 103 for the “R” rated portion of the program 100. As noted, alternative segment 103 is a commercial or advertisement that may be substituted for the R rated segment as a filler rather than blanking. In addition, the program content provider 1 has provided an “R” alternative segment 104 for the “PG-13” rated portion of the program 100.

These alternative segments are selected depending on the rating the viewer 11 has set and predetermined selection rules, e.g.,:

choose the next lower rating category until an appropriate content segment is found (e.g., R, then PG-13, then PG, then G);

always choose a predetermined rating (e.g., always G);

always choose the highest rating category available for that program segment;

always choose an alternative commercial or advertisement as a filler.

These selection rules are merely examples and it should be understood that other predetermined selection rules may also be used.

A storage medium, e.g., RAM 22 in FIG. 2, may be used in the receiver 10 to buffer some or all of the program 100 and alternatives 101-104. Initially, several seconds of the program 100 and any alternatives, if any, may be stored. This will allow the receiver 10 to display the information with a slight time delay. This time delay will allow the program content provider 1 to transmit the alternative content within the same bandwidth as the program 100 to be display. The selection of which version of the program content is displayed is based upon the rating the viewer has selected as discussed above.

In another embodiment, the alternative segments 101-104 may be separately transmitted via another medium. For example, the alternative segments 101-104 may be transmitted via another channel frequency (UHF or VHF), transmitted via an unused cable channel or provided from a memory medium such as a CD-ROM or floppy disk.

In another embodiment, the alternative segments 101-104 may be obtained via the network connection 60. The network connection 60 allows the receiver 10 to communication with to a remote database 61 such as TV network website. This would allow the receiver 10 to download the alternative segments 101-104 as needed.

To provide the receiver 10 an indication as to whether an alternative segment is available and where to fine the alternative segments, alternative segment location information (e.g., one or more data bytes) is included in EDS packet. The alternative segment location information contains synchronization information as well as information as to where to find the alternative segments. For example, the content advisory packet may indicate that alternative segments are available and where to find them.

The following table is an example of the alternative segment location byte (ASLB)code format.

| | | | | | | | | |
|---|---|---|---|---|---|---|---|---|
| ASLB byte | s7 | s6 | s5 | s4 | 13 | 12 | a1 | a0 |

Bits a0 and a1 are used to indicate the number of alternative segments. Bits 12 and 13 are used to indicate the location/source of the alternative segments. Bits s4-s7 are used to indicate the program 100 segment (e.g., segments 1 through 16 in this example with four bits).

| a1 | a0 | |
|---|---|---|
| 0 | 0 | zero alt segments |
| 0 | 1 | one alt segment |
| 1 | 0 | two alt segments |
| 1 | 1 | three alt segments |

| 12 | 13 | |
|---|---|---|
| 0 | 0 | alt segments sent with program |
| 0 | 1 | alt segments available at content provider remote database |
| 1 | 0 | alt segments available from UHF channel XX |
| 1 | 1 | alt segments available from cable channel YY |

Of course, multiple ASLB bytes and other byte formats may be used. For example, ASLB like information may be contained within the content advisory packet of the EDS. Alternatively, the ASLB code need only be sent once. The receiver 10 would then obtain all necessary information for the alternative segments 101-104 from the source indicated by the ASLB code. In this case, the ASLB code would essentially point to an alternative segment map for the entire program 100. The ASLB byte(s) may also include a rating code for each alternative segment.

In addition, the alternative segments 101-104 may also include a header containing information to synchronize and link the segments to the appropriate program 100 segment as well as a rating code for the alternative segment 101-104 (if not provided in the ASLB byte). Preferably, the alternative segments 101-103 for each segment of the program 100 are arranged in a predetermined order (e.g., highest content rating to lowest).

As discussed, the various embodiments of the invention allow viewers the ability to watch higher rated programs (e.g., R or PG-13) and selectively substitute alternative segments for those portions of the program display which may be objectionable. Rather than viewing a blank screen, the alternative content segments are substituted seamlessly for the objectionable program segments.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. A method of providing alternative information for a video program, the method comprising the steps of:
receiving a video signal including at least one rating code representing a program classification for a segment of the video signal and at least one alt-location code;
comparing the rating code with a predetermined program code;
determining whether an alternative segment is available based upon the alt-location code; and
substituting the alternative segment for the segment of the video program in dependence on a result of the comparison and a result of the determination.

2. The method according to claim 1, wherein the video signal is a television program.

3. The method according to claim 2, wherein alt-location code also identifies a source for obtaining the alternative segment.

4. The method according to claim 2, wherein the rating code and the alt-location code are received periodically and vary according to content contained within various segments of the video program.

5. The method according to claim 1, further comprising the step of entering and storing the predetermined program code.

6. The method according to claim 1, further comprising the step of extracting the rating code and the position code from the video signal using a data capture module.

7. The method according to claim 1, further comprising the step of comparing a predetermined alternative segment rating code associated with the alternative segment to the predetermined program code and the substitution is performed in dependence on results from both comparison steps.

8. A system for controlling display a video signal comprising:
a data capture module arranged to extract a rating code for a segment of the video signal and a alt-segment code from the video signal;
a comparitor that receives the rating code and compares the rating code to a predetermined program code;
a substitution circuit arranged to substitute an alternative segment for the segment of the video signal in dependence on a comparison result from the comparitor and the alt-segment code.

9. The system according to claim 8, wherein the data capture module forms part of a closed captioning system.

10. The system according to claim 9, wherein the video signal is a television program and the rating code and the alt-segment code are extracted from line 21 of the vertical blanking internal.

11. The system according to claim 8, wherein the data capture module forms part of a teletext system.

12. A television receiver comprising:
means for receiving a television signal including a rating code representing a program classification for a segment of the television signal and an alt-segment code inserted in a vertical blanking interval;
means for extracting the rating code and the alt-segment code;
means for comparing the rating code with a predetermined program code; and
means for determining whether an alternative segment is available based upon the alt-segment code; and
means for substituting the alternative segment for the segment of the television signal in dependence on a result of the comparison and a result of the determination.

13. The receiver according to claim 12, wherein alt-segment code also identifies a source of the alternative segment.

14. The receiver according to claim 12, wherein the rating code and the alt-segment code are received periodically and vary according to content contained within various segments of the television signal.

15. The receiver according to claim 12, further comprising means for entering and storing the predetermined program code.

16. The receiver according to claim 12, wherein said extracting means includes a data capture module and forms part of a closed captioning system.

17. The receiver according to claim 12, further comprising means for comparing a predetermined alternative segment rating code associated with the alternative segment to the predetermined program code and the substitution is performed in dependence on results from both comparisons.
